(19) United States
(12) Patent Application Publication
(10) Pub. No.: US 2024/0402825 A1
(43) Pub. Date: Dec. 5, 2024

(54) Active and Inactive Mode Transitions for User Input

(71) Applicant: Apple Inc., Cupertino, CA (US)

(72) Inventors: Daniel J. Brewer, Redwood City, CA (US); Bharat C. Dandu, Santa Clara, CA (US); David J. Meyer, Menlo Park, CA (US); Julian K. Shutzberg, San Francisco, CA (US); Lucas Soffer, Sunny Isles Beach, FL (US); Yirong Tang, Munich (DE)

(21) Appl. No.: 18/675,723

(22) Filed: May 28, 2024

Related U.S. Application Data
(60) Provisional application No. 63/505,894, filed on Jun. 2, 2023.

(51) Int. Cl. G06F 3/01

(52) U.S. Cl. CPC G06F 3/017

(57) ABSTRACT

Processing gesture input includes obtaining hand tracking data for a first hand based on one or more camera frames, detecting a first input gesture by the first hand based on the hand tracking data, and determining whether the first hand is in an active state. An input action associated with the first gesture is initiated in accordance with a determination that the first hand is in the active state. If, while the hand is in an active state, a determination is made that the inactive criterion is satisfied, then the first hand is transitioned to an inactive state.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties. Some XR environments allow multiple users to interact with virtual objects or with each other within the XR environment. For example, users may use gestures to interact with components of the XR environment. However, what is needed is an improved technique to manage tracking of a hand performing the gesture.

### BRIEF DESCRIPTION OF THE DRAWINGS

FIGS. 1A-1B show example diagrams of using active and inactive modes to process gesture-based user input, in accordance with one or more embodiments.

FIG. 2 shows a flow diagram of a technique for detecting input gestures, in accordance with some embodiments.

FIG. 3 shows a flowchart of a technique for determining intentionality of a gesture, in accordance with some embodiments.

FIG. 4 shows a flow diagram of an action network, in accordance with some embodiments.

FIG. 5 shows a flowchart of a technique for using active and inactive modes to process gesture-based user input, according to some embodiments.

FIG. 6 shows a flowchart of a technique for transitioning between active and inactive modes, in accordance with one or more embodiments.

FIG. 7 shows a system diagram of an electronic device which can be used for gesture recognition, in accordance with one or more embodiments.

FIG. 8 shows an exemplary system for use in various extended reality technologies.

### DETAILED DESCRIPTION

This disclosure pertains to systems, methods, and computer readable media to enable gesture recognition and input. In some enhanced reality contexts, image data and/or other sensor data can be used to detect gestures by tracking hand data. However, a user using gesture-based input may unintentionally perform gestures that may be recognized as user input. To reduce the number of accidental input gestures, hands can be labeled as either in an active mode or an inactive mode. The different modes may be associated with different parameters by which gesture input is recognized.

In some embodiments, each hand may be labeled as active or inactive based on various factors. These factors may include specific detected triggering events or conditions which cause a hand to transition from an inactive state to an active state. Similarly, certain detected triggering events or conditions may cause a hand to transition from an active state to an inactive state. The active state and the inactive state may be associated with different gesture recognition parameters. That is, parameters by which a gesture is recognized by a hand in an active state may be satisfied more easily than parameters by which a gesture is recognized by a hand in an inactive state.

Embodiments described herein provide an improved gesture-based user interface by reducing the likelihood of input actions being initiated when a hand is in an inactive state as compared to an active state. By doing so, responsiveness to user input gestures is improved when a user is most likely interacting with a gesture-based user interface. At the same time, accidental input is reduced by limiting actions that cause gesture-based input during an inactive state.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

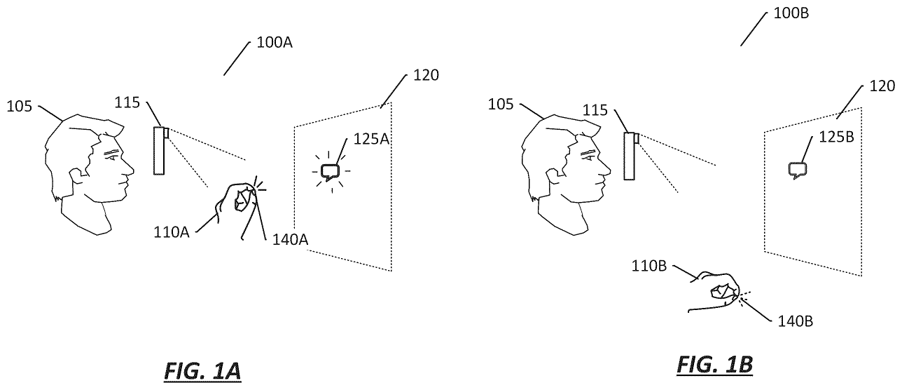

FIG. 1A shows a diagram of a technique for using active and inactive modes to process gesture-based user input, in accordance with one or more embodiments. In particular, in a first view, 100A, a user 105 is shown attempting a selection gesture. A device 115 may obtain sensor data of the user's hand 110A. It should be understood that although the user interface 120 is depicted separate from the device 115, in some embodiments, the user interface 120 may be presented on a display of the device 115. In some embodiments, the device 115 may use hand tracking or other vision-based tracking networks or procedures. That is, an electronic device 115 may have one or more cameras or other sensors configured on or in the device in a manner such that images of the hand or other body tracking data, e.g., depth of locations on the hand, is captured. The electronic device 115 may be a mobile device such as a wearable device with cameras and/or other sensors facing toward the user's hands.

According to some embodiments, the device may use the sensor data to detect user input gestures and to process user input accordingly. In some embodiments, the device 115 may determine an input action associated with a detected user input gesture based on the hand pose and/or other tracking data. In some embodiments, the device 115 can determine whether a hand pose and/or other tracking data should trigger an input action based on an active or inactive mode of a particular hand. That is, the device 115 can determine a mode for the hands (or, in some embodiments, each hand). Whether a hand is in an active state or an inactive state may cause the device to detect or determine whether a user input action should be triggered based on a respective set of criteria. As described above, the device may use different parameters for determining whether a hand pose triggering an input action is detected when the hand is in an inactive state versus when a hand is in an active state. However, the parameters used to trigger an input action may be less permissive in an inactive mode than in an active state. Said another way, a user input action may be triggered by a hand pose when in an active state or inactive state. However, in an inactive state, the parameters by which a user input action is triggered are more difficult to satisfy than when a hand is in an active state.

As will be described below, various acceptor and rejector actions may be considered in determining whether a hand is in an active or inactive mode. For purposes of this example, hand 110A is in an active state. In this example, hand 110A is performing a pinch gesture, which is determined to be a valid input gesture for triggering a user input action, as shown at 140A. As such, the user input component 125A is shown as selected.

Turning to FIG. 1B shows an alternative diagram of a technique for using active and inactive modes to process gesture-based user input, in accordance with one or more embodiments. In particular, in the second view, 100B, a user 105 is shown attempting a selection gesture. A device 115 may capture sensor data of the user's hand 110B at a different position than pose of hand 110A of FIG. 1A. As in FIG. 1A, it should be understood that although the user interface 120 is depicted separate from the device 115, in some embodiments, the user interface 120 may be presented on a display of the device 115. In some embodiments, the device 115 may be the device may use hand tracking or other vision-based tracking networks or procedures. That is, an electronic device 115 may have one or more cameras or other sensors configured on or in the device in a manner such that images of the hand or other body tracking data is captured. The electronic device 115 may be a mobile device such as a wearable device with cameras and/or other sensors facing toward the user's hands.

According to some embodiments, the device 115 may use the sensor data to detect user input gestures and to process user input accordingly. In some embodiments, the device 115 may determine an input action associated with a detected user input gesture based on the hand pose and/or other tracking data. As described above, the device may use a set of parameters for determining whether a hand pose triggering an input action is detected when the hand is in an inactive state which are more difficult to satisfy than a set of parameters used for determining whether the hand pose triggers an input action when a hand is in an active state. Said another way, a user input action may be triggered by a hand pose when in an active state or inactive state. However, in an inactive state, the parameters by which a user input action is triggered are more strict than when a hand is in an active state. Said another way, the probability that the hand tracking data causes the input action to be triggered is greater in the active state than in the inactive state.

As will be described below, various acceptor and rejector actions may be considered in determining whether a hand is in an active or inactive mode. For purposes of this example, hand 110B is in an inactive mode. Examples of rejection actions which cause a hand to be considered to be in an inactive mode include determinations that the user is using a peripheral device (for example either based on hand pose or detected inputs at a peripheral device), self-interaction type poses, a timeout event from a last valid gesture input action, or the like. Further, in some embodiments, a user can actively enter an inactive mode by particular gesture or other predefined user input action or event. Other examples of rejectors include, for a pinch gesture, detecting that a palm is face down and peripheral events are received, detecting that the hand or hands are palm down in a peripheral use pose, detecting that a hand has dropped to a stationary pose, or predefined rejector actions such as when a thumb and index slide along each other. Any or some combination of these rejector actions would cause a hand to be placed in an inactive mode, and for a corresponding gesture, such as the pinch, to be rejected.

In this example, hand 110B is performing a pinch gesture, as shown at 140B. For purposes of this example, the pose of the hand is at the user's side, which may be considered a pose consistent with the use of a peripheral device, which could cause the device 115 to label to hand 110A as being in an inactive s. Because the hand is in an inactive mode, the pinch gesture is not determined to be a valid input gesture for triggering a user input action. As such, the user input component 125B remains unselected.

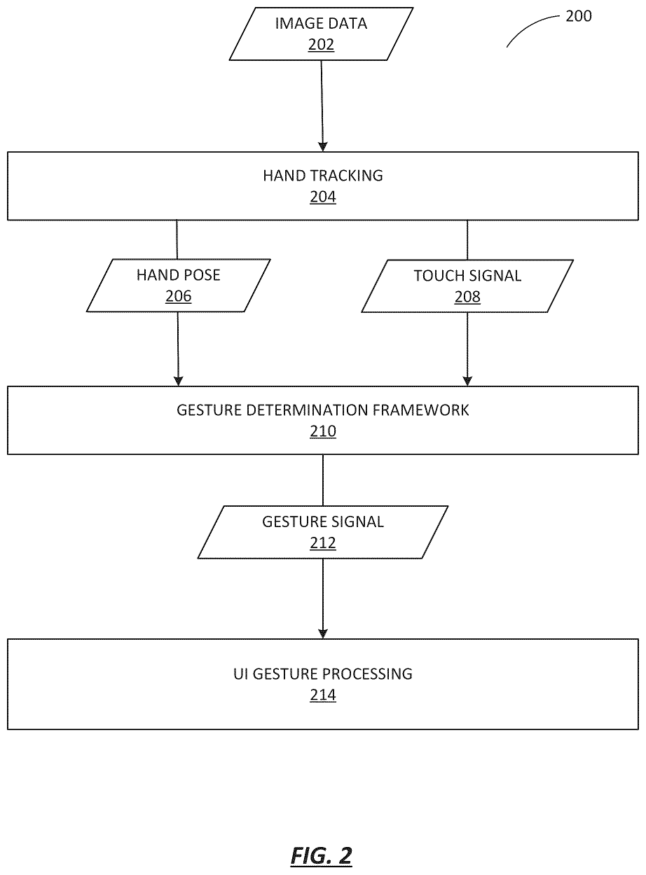

FIG. 2 shows a flow diagram of a technique for detecting input gestures, in accordance with some embodiments. In particular, FIG. 2 shows a gesture estimation pipeline in which a user input gesture is recognized and processed. Although the flow diagram shows various components which are described as performing particular processes, it should be understood that the flow of the diagram may be different in accordance with some embodiments, and the functionality of the components may be different in accordance with some embodiments.

The flow diagram 200 begins with sensor data 202. In some embodiments, the sensors data may include image data and/or depth data captured of a user's hand or hands. In some embodiments, the sensor data may be captured from sensors on an electronic device, such as outward facing cameras on a head mounted device, or cameras otherwise configured in an electronic device to capture sensor data including a user's hands. According to one or more embodiments, the sensor data may be captured by one or more cameras, which may include one or more sets of stereoscopic cameras. In some embodiments, the sensor data 202 may include additional data collected by an electronic device and related to the user. For example, the sensor data may provide location data for the electronic device, such as position and orientation of the device.

In some embodiments, the sensor data 202 may be applied to a hand tracking network 204. The hand tracking network may be a network trained to estimate a physical state of a user's hand or hands. In some embodiments, the hand tracking network 204 predicts a hand pose 206. The hand pose may be a classified pose of a hand based on the estimated physical state, or may provide some other form of data indicative of a pose of a hand. For example, in some embodiments, the hand pose data 206 may include an estimation of joint location for a hand. Further, in some embodiments, the hand tracking network 204 may be trained to provide an estimation of an estimate of a device location, such as a headset, and/or simulation world space.

In some embodiments, the hand tracking network 204 may further be configured to provide touch data. The touch data may include a prediction as to whether, for a given frame or frames, a touch is occurring between two regions on the hand. For example, a machine learning model may be trained to predict whether a thumb pad and index finger are in contact. For purposes of the description herein, a touch refers to contact between two surfaces regardless of intent, whereas a pinch is defined as a touch being performed with the intent of producing a corresponding input action. As will be described in greater detail below, in some embodiments, the hand tracking may predict whether a touch occurs based on the sensor data 202 and/or hand pose data 206.

According to one or more embodiments, gesture determination framework 210 provides a determination as to whether a particular pose presented in the sensor data 202 is intentional. That is, a determination is made as to whether a classified pose of the hand (for example, based on or provided by the hand pose data 206) is intentional. When the determined hand pose includes a touch, such as a pinch, then the gesture determination framework 210, may use the touch signal 208 provided by the hand tracking network 204 in determining whether an intentional gesture is performed.

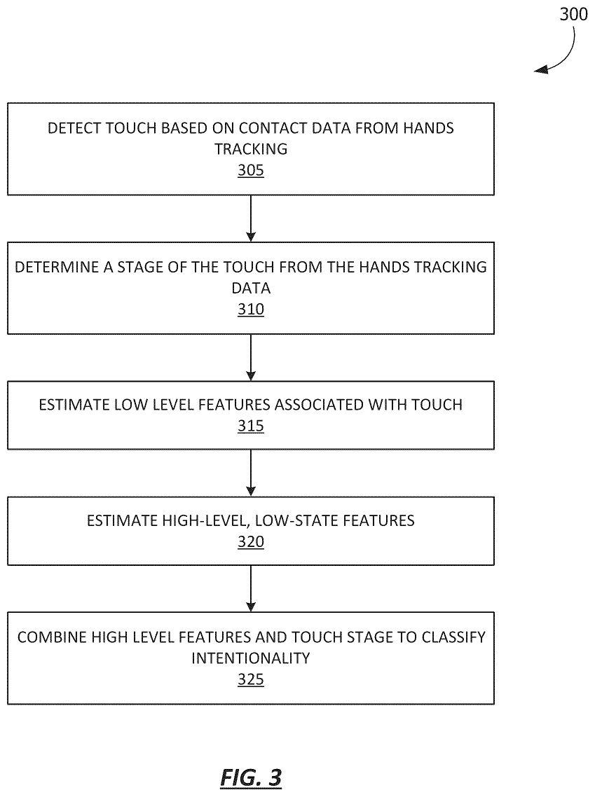

In some embodiments, the gesture determination framework 210 may utilize additional data not explicitly depicted in FIG. 1. For example, the gesture determination framework 110 may receive signals such as user interface (UI) geometry, gaze estimation, events generated by connected peripherals, user interaction with objects, and the like. As will be described in FIG. 3., the gesture determination framework 110 may consider the various features from the inputs to make a determination for a particular input gesture, whether the gesture is intentional. This determination may be transmitted in the form of a gesture signal 112 to a UI gesture processing module 114. The gesture signal may indicate whether or not an intentional input gesture has occurred. In some embodiments, the gesture signal 112 may also be used to indicate whether a previous gesture signal should be cancelled. This may occur, for example, if a user shifts their position, sets their hands down, or the like.

According to one or more embodiments, the hand pose data 206 and/or touch signal 208 may be determined based on a set of heuristics, as will be described in greater detail below. These heuristics may be used to determine whether a hand pose 206 is associated with a user input gesture. In some embodiments, multiple sets or hierarchies of parameters may be used to determine whether a hand pose is associated with a user input gesture. The particular parameters used to determine whether a hand pose is associated with a user input gesture may be based on whether the associated hand is in an active mode or an inactive mode. The device may assign one or both hands to an active or inactive mode based on various acceptor or rejector actions. Generally, a device assigns a model to one or both hands based on a determination that the hand is actively engaged with a user interface through gesture-based input. This can occur based on certain predefined events (e.g., acceptor events), or contextual cues from the user and/or UI.

Examples of acceptor events include, for example, detecting a nominal gesture tap. This may include a short duration, stationary pinch. For example, a nominal gesture tap may be detected as a pinch that occurs within a threshold timeframe, and includes less than a threshold movement. Another example of an acceptor event includes detection of an intentional scroll. An intentional scroll may be detected, for example, based on a velocity at which fingers come together to form a pinch, and when a hand moves beyond a threshold distance while the fingers are still pinched. A third example of an acceptor event includes a very fast pinch with a strong pinch style. A strong pinch style may be defined by a motion which is defined as a typical pinching motion. A fourth example of an acceptor event includes a repeated action, such as a repeated pinch. In some embodiments, the repeated pinch may be detected when two pinches are detected in a consecutive manner within a threshold distance and, optionally, with an associated gaze directed within a threshold distance. In some embodiments, acceptor events may be impervious to hand mode. That is, a gesture that satisfies an acceptor event will trigger a user input action regardless of whether the hand is in an active state or an inactive state.

In some embodiments, each of these example acceptor events may trigger a corresponding user input action both when a hand is within an active state and when a hand is in an inactive state. However, the parameters used during an inactive mode by which the event is detected so as to trigger a user input action may be more difficult to satisfy as compared to parameters used during an active mode. As an example, with respect to the nominal gesture tap, the timeframe and/or threshold movement may be more difficult to satisfy in an inactive mode such that in order to trigger a user input action, the nominal gesture tap may satisfy more narrowly defined parameters. Similarly, with an intentional scroll, the required velocity and/or threshold distance may be different in an active mode and an inactive mode so as to trigger a user input scroll. Further, with respect to the fast pinch, a pinch may require a better-defined pinch style in an inactive mode than in an active mode. In some embodiments, the parameters used in an inactive mode may rely on additional data than the parameters used during an active mode. As an example, a well-defined pinch may trigger a user input action in an active mode, but in an inactive mode, gaze tracking data must indicate that the user is gazing at a user input component.

In some embodiments, the heuristics used to determine a hand pose 206 or touch signal 208 may be modified dynamically based on a given state of a hand. Additionally, or alternatively, the particular state of a hand may be considered by the gesture determination framework 210 for determining whether a gesture triggers a user input action, and thereby provides an appropriate gesture signal 212. In particular, in some embodiments, the state of the hand may be taken into consideration in determining an intentionality of a gesture.

The UI gesture processing module 214 may be configured to enable a user input action based on the gesture signal 212. A particular gesture, such as a pinch, may be associated with a selection action of a UI component or the like. In some embodiments, if a cancellation signal is received corresponding to a gesture signal 212 which has already been initiated, the system can process that gesture differently than if it were not cancelled. For example, a UI component can be shown as selected but not activated, etc. As another example, a previously initiated stroke drawn by the user can be truncated or undone.

As described above, the gesture determination framework may be configured to generate a classification of intentionality for a gesture. The gesture determination framework 210 may be configured to estimate a pose or gesture of a hand, and determine whether the gesture was intended to be used for triggering a user input action. FIG. 3 shows a flowchart of a technique for classifying intentionality of a gesture, in accordance with some embodiments. For purposes of explanation, the following steps will be described as being performed by particular components of FIG. 2. However, it should be understood that the various actions may be performed by alternate components. The various actions may be performed in a different order. Further, some actions may be performed simultaneously, and some may not be required, or others may be added.

The flowchart 300 begins at block 305, where a touch is detected based on context data from the hand tracking network. The touch may be detected, for example, based on a touch signal 208 received from the hand tracking network 204. According to some embodiments, some gestures may require touch, such as a pinch or the like. Further, multiple types of pinches may be recognized with different kinds of touch. According to some embodiments, not every gesture may require a touch. As such, the touch may not be detected, or the touch signal may indicate that the touch occurs. In some embodiments, the touch signal may not be received, or may otherwise be ignored and a gesture may still be recognized.

The flowchart 300 continues to block 310, where a touch stage is determined from hand tracking data. The touch stage may indicate, for a given frame, what phase of the touch action the fingers are currently in. According to some embodiments, the features of interest in determining intentionality may vary depending upon a current state of a gesture. For gestures that include a pinch or other touch action, the stage in which the gesture is currently in may affect the ability to enable, cancel, or reject an associated input action. Some examples of touch stage include an idle state, an entry state in which a touch event is beginning, such as a pinch down phase. A hold state, where a pinch is currently occurring, and an exit stage, for example when a pinch up occurs for the pinch is ending.

At block 315, low-level features are estimated in association with the touch. The low-level features may be determined from the hand tracking data and/or additional data may include estimations of what a hand is doing during the frame. For example, other sources of data include pose information for a device capturing the hand tracking data, hand pose, UI geometry, gaze estimation, etc. In some embodiments, the low-level features are determined without regard for intent. Examples of low-level features include, for example, a pinch speed on pinch down, a measure of wrist flex, finger curl, proximity of hand to head, velocity of hand, and the like.

The flowchart 300 continues to block 320, where high-level, low-state features are estimated. The high-level, low-state features may include modal features which estimate what a user is doing during the touch in order to determine intentionality. In some embodiments, the high-level features may be features which are interoperable, and which can be individually validated. Examples include, estimates as to whether hands are using one or more peripheral devices, a frequency of a repetition of a gesture (for example, if a user is pinching repeatedly), if hand is holding an object, if a hand is in a resting position, a particular pinch or gesture style (i.e., a pinch using pads of two fingers, or using the side of a finger). In some embodiments, the high-level features may be based on user activity, such as a user fidgeting, talking, or reading. According to one or more embodiments, the high-level features may be determined based on the hand tracking data, the determined touch stage, and/or the estimated basic features. In some embodiments, the high-level features may directly determine intentionality of an action. As an example, if a user is using a peripheral device such as a keyboard, a pinch may be rejected, or the gesture may be determined to be unintentional.

According to one or more embodiments, the high-level features may be used to determine various acceptor and rejector events. As described above, examples of acceptor events include, for example, detecting a nominal gesture tap, detection of an intentional scroll, a very fast pinch with a strong pinch style, and a repeated action, such as a repeated pinch. These acceptor actions indicate that the hand should be in an active mode. Examples of rejector events include determining self-interaction, which may be detected when a hand is near another part of the user, such as an arm or other part of the body. By determining that the hand is near another portion of the user, the hand may be determined to be engaging in self-interaction, and the hand may be considered to be in an inactive mode. As another example, the high level features may indicate that the user is likely in a peripheral use mode, either based on user pose or user input or other signals. A determination that the user is in a peripheral user mode may trigger the hand to be placed in an inactive mode.

The flowchart concludes at block 325, where the gesture determination framework 210 combines high level features and the touch stage to classify intentionality. In some embodiments, the gesture determination framework 210, uses a conditional combination of high-level features and touch stage to classify intentionality. The classification can then be used to signal the gesture to be processed as an input gesture (thereby activating an associated UI input action), cancel the associated action if the gesture is determined to be unintentional (for example, if a UI action associated with the gesture has already been initiated), or disregard the gesture.

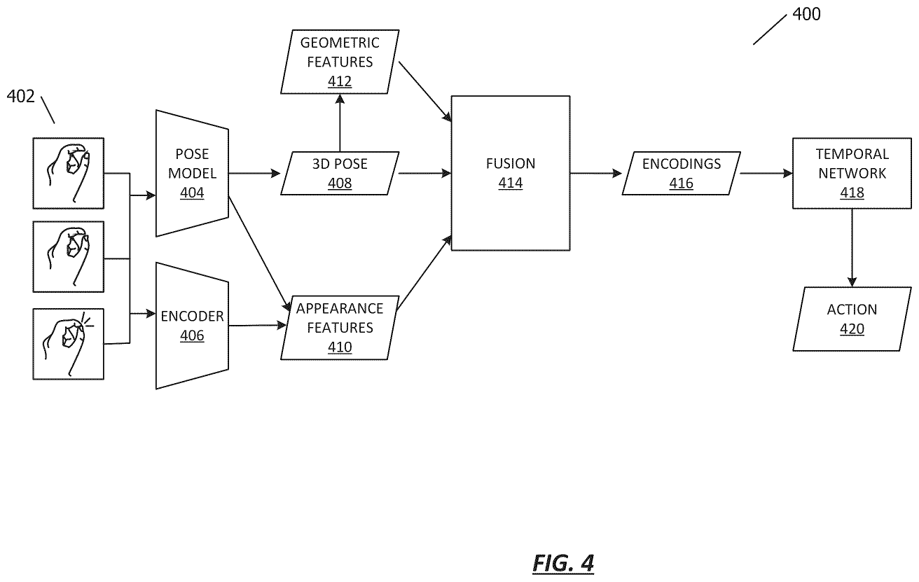

The touch signal 208 of FIG. 2, can be determined in a number of ways. For example, in some embodiments, heuristics can be used based on the hand tracking data to determine whether a touch has occurred, and/or a current touch stage. FIG. 4 shows a flow diagram of an action network, in accordance with some embodiments, which provides an example machine learning process for determining whether a touch has occurred.

The pipeline 400 begins with a set of frames 402 as input. The frames 402 may be a temporal series of image frames of a hand captured by one or more cameras. The cameras may be individual cameras, stereo cameras, cameras for which the camera exposures have been synchronized, or a combination thereof. The cameras may be situated on a user's electronic device, such as a mobile device or a head mounted device. The frames may include a series of one or more frames associated with a predetermined time. For example, the frames 402 may include a series of individual frames captured at consecutive times, or can include multiple frames captured at each of the consecutive times. The entirety of the frames may represent a motion sequence of a hand from which a touch may be detected or not for any particular time.

The frames 402 may be applied to a pose model 404. The pose model 404 may be a trained neural network configured to predict a 3D pose 408 of a hand based on a given frame (or set of frames, for example in the case of a stereoscopic camera) for a given time. That is, each frame of frame set 402 may be applied to pose model 404 to generate a 3D pose 408. As such, the pose model can predict the pose of a hand at a particular point in time. In some embodiments, geometric features 412 may be derived from the 3D pose 408. The geometric features may indicate relational features among the joints of the hand, which may be identified by the 3D pose. That is, in some embodiments, the 3D pose 408 may indicate a position and location of joints in the hand, whereas the geometric features 412 may indicate the spatial relationship between the joints. As an example, the geometric features 412 may indicate a distance between two joints, etc.

In some embodiments, the frames 402 may additionally be applied to an encoder 406, which is trained to generate latent values for a given input frame (or frames) from a particular time indicative of an appearance of the hand. The appearance features 410 may be features which can be identifiable from the frames 402, but not particularly useful for pose. As such, these appearance features may be overlooked by the pose model 404, but may be useful within the pipeline 400 to determine whether a touch occurs. For example, the appearance features 410 may be complementary features to the geometric features 412 or 3D pose 408 to further the goal of determining a particular action 420, such as whether a touch has occurred. According to some embodiments, the encoder 406 may be part of a network that is related to the pose model 404, such that the encoder may use some of the pose data for predicting appearance features. Further, in some embodiments, the 3D pose 408 and the appearance features 410 may be predicted by a single model, or two separate, unrelated models. The result of the encoder 406 may be a set of appearance features 410, for example, in the form of a set of latents.

A fusion network 414 is configured to receive as input, the geometric features 412, 3D pose 408, and appearance features 410, and generate, per time, a set of encodings 416. The fusion network 414 may combine the geometric features 412, 3D pose 408, and appearance features 410 in any number of ways. For example, the various features can be weighted in the combination in different ways or otherwise combined in different ways to obtain a set of encodings 416 per time.

The encodings are then run through a temporal network 418, to determine an action 420 per time. The action 420 may indicate, for example, whether a touch, or change in touch stage has occurred or not. The temporal network 418 may consider both a frame (or set of frames) for a particular time for which the action 420 is determined, as well as other frames in the frame set 402.

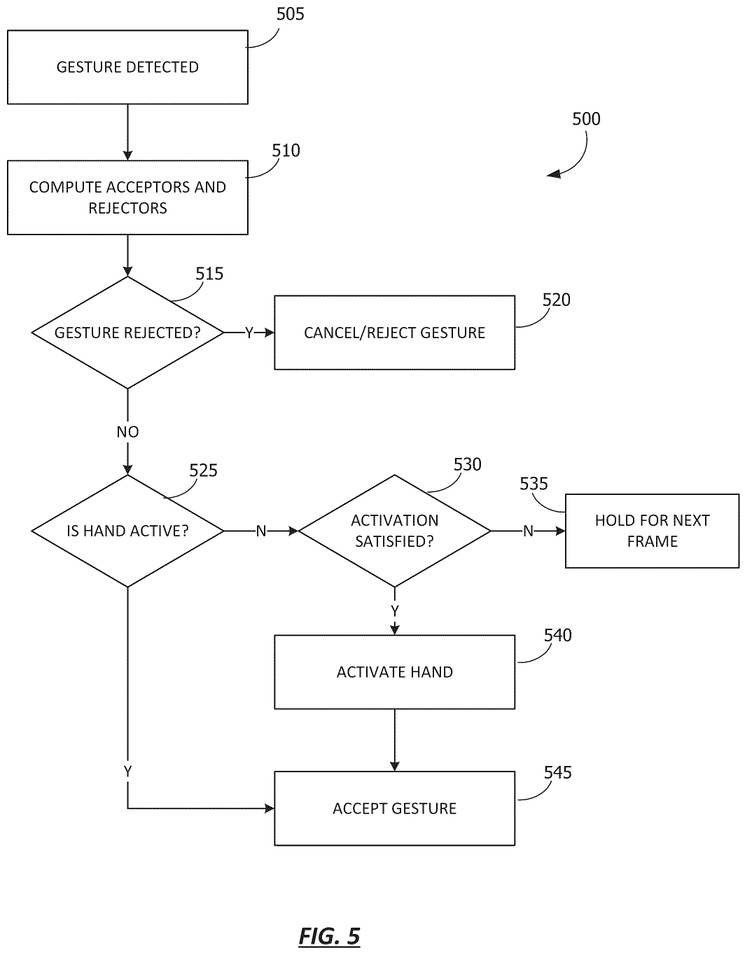

FIG. 5 shows a flowchart of a technique for using active and inactive modes to process gesture-based user input, according to some embodiments. In particular, the flowchart presented in FIG. 5 depicts an example technique for detecting and processing gestures, as described above with respect to FIG. 1. For purposes of explanation, the following steps will be described as performed by particular components. However, it should be understood, that the various actions may be performed by alternate components. In addition, the various actions may be performed in a different order. Further, some actions may be performed simultaneously, and some may not be required, or others may be added.

The flowchart 500 begins at block 505, where a gesture is detected. In some embodiments, the device may select a gesture from among a set of predefined gesture classifications based on the pose. In some embodiments, the gesture may be based on hand pose in a single frame (or, in some embodiments, stereoscopic frame pair), over a series of frames, or the like. The gesture may be determined, for example, by a gesture determination framework 210, as described above. In some embodiments, the gesture may be detected based on a hand pose and/or a touch signal received from a hand tracking pipeline. The hand tracking pipeline may be configured to obtain hand tracking data from one or more sensors on a device. The hand tracking data may be obtained from one or more cameras, including stereoscopic cameras or the like. In some embodiments, the hand tracking data may include sensor data captured by outward facing cameras of a head mounted device.

The flowchart 500 continues at block 510, where acceptors and rejectors are computed. In some embodiments, upon detecting a gesture, a determination is made as to whether any acceptor actions or rejector actions are present. However, the computation of acceptors and rejectors may occur at different times. According to some embodiments, the acceptors and rejectors may be the same for active and inactive modes, or may be different.

Acceptors may include events which indicate that a particular hand or hands are in an active mode. Acceptor events include, for example, detecting a nominal gesture tap, detection of an intentional scroll, a very fast pinch with a strong pinch style, and a repeated action, such as a repeated pinch. These acceptor actions indicate that the hand should be in an active mode. Examples of rejector events include determining self-interaction, which may be detected when a hand is near another part of the user, such as an arm or other part of the body. By determining that the hand is near another portion of the user, the hand may be determined to be engaging in self-interaction, and the hand may be considered to be in an inactive mode. As another example, the high level features may indicate that the user is likely in a peripheral use mode, either based on user pose or user input or other signals. A determination that the user is in a peripheral user mode may trigger the hand to be placed in an inactive mode.

The flowchart proceeds to block 515, where a determination is made as to whether a gesture is rejected. That is, an attempted gesture at block 505 may be rejected based on a detected rejector action. If the gesture is rejected, then the flowchart concludes at block 520 and the gesture is either cancelled or rejected. If an input action has not begun for the gesture, then the gesture is disregarded with respect to any associated user input action. In some embodiments, determining that a gesture is rejected causes a particular hand or hands used to perform the gesture to be labeled by the device as being in an inactive mode, or may contribute to the hand being labeled as being in an inactive mode. However, in some embodiments, the particular hand or hands may remain in a current mode regardless of if the gesture is rejected.

According to some embodiments, a gesture may be rejected at various times during a gesture. As such, it is possible that an input action associated with the gesture may be initiated prior to the gesture being rejected. For example, a user may be using a peripheral device, such as a keyboard. Hand tracking data may detect that the hand is performing an input gesture based on hand pose while the user is typing. In response, the device may initiate a user input action associated with the detected gesture. The user input action may include, for example, a visual cue for a particular UI component affected by the gesture, as well as the associated action. When the rejector action is determined, the user input action may be cancelled such that the visual cue is no longer presented, and/or the resulting input action is discarded. According to some embodiments, cancelling the input action may include rolling back any user input action that has begun. For example, if the user input action included a dragging motion of a UI component, the UI component may be returned to its original position in response to the cancellation.

Returning to block 515, if the gesture is not rejected, then the flowchart 500 proceeds to block 525 and a determination is made as to whether the hand is active. The hand is determined to be active if the hand has been labeled in an active state by the device. For example, the hand may be in an active state based on a prior detected acceptor event. If the gesture is not rejected, and the hand is active, then the flowchart concludes at block 545 and the gesture is accepted. According to one or more embodiments, accepting the gesture causes the associated input action to be performed.

In some embodiments, a gesture may be recognized regardless of whether a hand is in an active state or an inactive mode. However, the parameters by which the gesture causes an associated user input action to be performed may vary. As such, returning to block 525, if the gesture is not rejected, but the hand is note active, then the flowchart 500 proceeds to block 530, and a determination is made as to whether an activation criteria is satisfied. The activation criteria may include detecting that one of the acceptor actions is detected at block 510. That is, when the hand is inactive, a gesture is accepted based on an acceptor action being detected. The acceptor action may be associated with parameters more difficult to satisfy for a gesture than parameters used during an active state. That is, acceptors may not be meaningful when a hand is already in an active state, but may be useful when a hand is in an inactive state. By contrast, rejectors may be useful both when a hand is in an active state and when a hand is in an inactive state.

If a determination is made at block 530 that an activation state is not satisfied, then no user input action is performed, and the hand is held in an inactive state for the next frame, as shown at block 535. As such, the lack of an activation from an inactive state does not change the state of the hand.

Returning to block 530, if an activation criteria is satisfied, then the flowchart proceeds to block 540 and the hand is activated. In some embodiments, a hand is activated by labeling a particular hand or hands as being in an active mode. Then, the flowchart concludes and the gesture is accepted at block 545. In some embodiments, accepting the gesture may include performing a user input action associated with the gesture.

According to some embodiments, determining whether a hand or hands should be placed in an inactive mode may be determined in response to detecting a gesture or attempted gesture by the hand or hands. Additionally, or alternatively, the determination as to whether to place the hand or hands in an inactive mode may be made upon detection of system events (such as input from a peripheral device, body tracking data such as a quick drop of arms or retraction of arms towards the torso), timeout events, or the like.

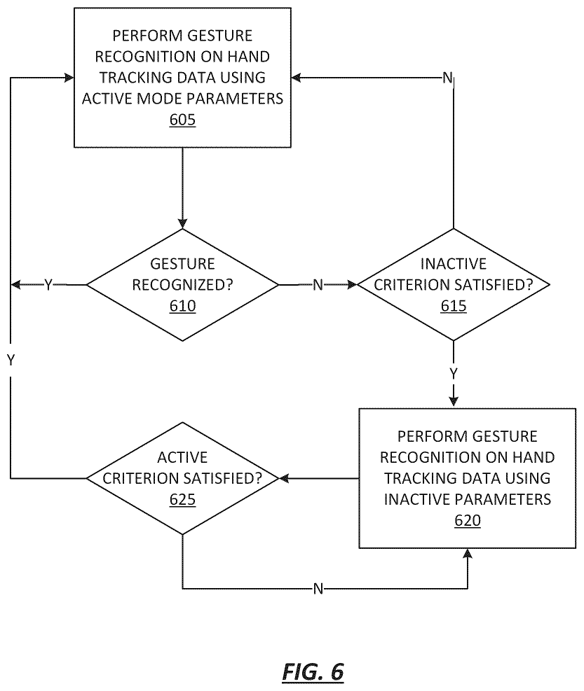

FIG. 6 shows a flowchart of a technique for transitioning between active and inactive modes, in accordance with one or more embodiments. In particular, FIG. 6 depicts a state diagram of transitions between an active mode and an inactive mode in accordance with one or more embodiments.

The state diagram begins at block 605, where gesture recognition is performed on hand tracking data using parameters for one or more gestures associated with an active mode. This process presumes that the state diagram begins with a hand in an active state. Alternatively, if the process begins with a hand in an inactive mode, the state diagram may begin at block 620, as will be described below. For purposes of this description, the state diagram begins at block 605, and parameters for one or more gestures associated with the active mode are used. Performing gesture recognition in the active mode may include, for example, performing gesture recognition using parameters that are easily satisfied than if the hand were in an inactive mode. That is, because the hand is determined to be actively engaged with a user interface, a gesture is less likely to be unintentional and, thus, the gesture is more likely to trigger a user input action.

The flow diagram continues to block 610, where a determination is made as to whether a gesture is recognized. A gesture may be recognized, for example, using the gesture determination framework 210 described above. In some embodiments, a gesture may be recognized as an attempted gesture, but merely recognizing an attempted gesture is insufficient for triggering an associated user input action. Rather, once a potential gesture is detected, a determination is made as to whether to accept or reject the gesture. This may occur, for example, within the gesture determination framework 210, or in a separate pipeline prior to producing a gesture signal 212. A gesture may be recognized, for example, based on a general set of parameters applied to hand tracking data and/or other tracking data collected by the device.

If the gesture is not recognized at block 610, then the diagram continues to block 615, and a determination is made as to whether an inactive criterion is satisfied at block 615. The inactive criterion may be one or more actions or events which cause the device to determine that a particular hand or hands are not actively interacting with a user interface. That is, the determination may be made on a single hand basis, or for both hands. The inactive criterion may be based on the unrecognized gesture, or may be based on separate contextual cues. The inactive criterion may include, for example, detecting a rejector event as described above. In addition to particular actions or contextual cues, rejector events can also include timeout events, or the like. That is, in some embodiments, if a gesture is not recognized for a predetermined amount of time, a hand or hands may be placed in an inactive mode. If an inactive criterion is not satisfied, the flowchart proceeds to block 605 and the hand or hands remain in an active mode. At block 605, gesture recognition continues using active mode parameters.

Returning to 610, if a determination is made that the gesture is recognized, then the flow also proceeds to block 605 and the hand or hands remain in an active mode. At block 605, gesture recognition continues using active mode parameters. Notably, when the determination is made at block 610, the hand or hands are in an active mode. As such, if a gesture is recognized, the hands stay in an active mode. Although not shown, a recognized gesture may trigger a user input action associated with the recognized gesture.

Returning to block 615, if a determination is made that an inactive criterion is satisfied while a hand is in an active mode, then the flow diagram proceeds to block 620 where gesture recognition is performed on hand tracking data using parameters associated with the inactive mode. That is, if the inactive criterion is satisfied at block 615, then the device may label or otherwise consider the affected hand or hands to be in an inactive mode. From there, gesture recognition is performed on any subsequent data using parameters associated with an inactive mode.

As described above, in some embodiments, once the hand is in an inactive mode, then gestures will not trigger user input until an acceptor event is detected, thereby triggering the hand to be placed in the active mode (and allowing the triggering gesture, if applicable, to initiate an associated user input action). Thus, in some embodiments, performing gesture recognition at block 620 may include monitoring hand tracking data and/or other data to determine whether an acceptor event or action is detected.

The flow proceeds to block 625 where a determination is made regarding whether an active mode criterion is satisfied. An active mode criterion may be used to determine whether to transition a hand to an active mode. Examples of active mode criteria may include a recognized gesture which cause an input action. A gesture may be recognized, for example, using the gesture determination framework 210 described above. In some embodiments, a gesture may be recognized as an attempted gesture, but merely recognizing an attempted gesture is insufficient for triggering an associated user input action. Rather, once a potential gesture is detected, a determination is made as to whether to accept or reject the gesture. This may occur, for example, within the gesture determination framework 210, or in a separate pipeline prior to producing a gesture signal 212. A gesture may be recognized, for example, based on a general set of parameters applied to hand tracking data and/or other tracking data collected by the device. In some embodiments, the gesture is recognized using the inactive parameters associated with the inactive mode, which may be more difficult to satisfy than parameters associated with an active mode applied to hand tracking data when a hand is in an active mode. Notably, the active criterion (used to transition the hand to an active mode) and the inactive criterion (used to transition the hand to an inactive mode) may be different from each other, and may not mirror each other.

If at block 625, a determination is made that an active criterion is not satisfied, then the flow proceeds to block 620 and gesture recognition continues to be performed on additional received hand tracking data and/or other data using the inactive parameters. Returning to block 625, if a determination is made that the active criterion is satisfied, then the hand or hands is placed in an active mode, and the flow returns to block 605, where additional hand tracking data is processed using the active mode parameters.

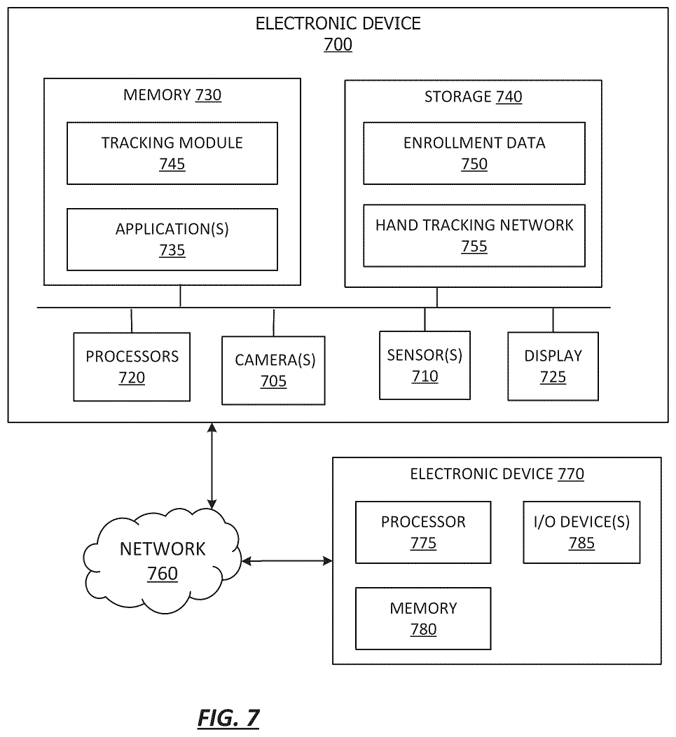

Referring to FIG. 7, a simplified block diagram of an electronic device 700 is depicted. Electronic device 700 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 700 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 700 is utilized to interact with a user interface of one or more application(s) 735. It should be understood that the various components and functionality within electronic device 700 may be differently distributed across the modules or components, or even across additional devices.

Electronic Device 700 may include one or more processors 720, such as a central processing unit (CPU) or graphics processing unit (GPU). Electronic device 700 may also include a memory 730. Memory 730 may include one or more different types of memory, which may be used for performing device functions in conjunction with processor(s) 720. For example, memory 730 may include cache, ROM, RAM, or any kind of transitory or non-transitory computer-readable storage medium capable of storing computer-readable code. Memory 730 may store various programming modules for execution by processor(s) 720, including tracking module 745, and other various application(s) 735. Electronic device 700 may also include storage 740. Storage 740 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 740 may be utilized to store various data and structures which may be utilized for storing data related to hand tracking and UI preferences. Storage 740 may be configured to store hand tracking network 755 according to one or more embodiments. Storage 740 may further be configured to store user-specific data to facilitate hand tracking, such as hand size, bone length, user preferences, and the like as enrollment data 750. Electronic device may additionally include a network interface from which the electronic device 700 can communicate across a network.

Electronic device 700 may also include one or more cameras 705 or other sensors 710, such as a depth sensor, from which depth of a scene may be determined. In one or more embodiments, each of the one or more cameras 705 may be a traditional RGB camera or a depth camera. Further, cameras 705 may include a stereo camera or other multicamera system. In addition, electronic device 700 may include other sensors which may collect sensor data for tracking user movements, such as a depth camera, infrared sensors, or orientation sensors, such as one or more gyroscopes, accelerometers, and the like.

According to one or more embodiments, memory 730 may include one or more modules that comprise computer-readable code executable by the processor(s) 720 to perform functions. Memory 730 may include, for example, tracking module 745, and one or more application(s) 735. Tracking module 745 may be used to track locations of hands and other user motion in a physical environment, and to determine whether a hand is in an active or inactive state. Tracking module 745 may use sensor data, such as data from cameras 705 and/or sensors 710. In some embodiments, tracking module 745 may track user movements to determine whether to trigger user input from a detected input gesture. Electronic device 700 may also include a display 725 which may present a UI for interaction by a user. The UI may be associated with one or more of the application(s) 735, for example. Display 725 may be an opaque display or may be semitransparent or transparent. Display 725 may incorporate LEDs, OLEDs, a digital light projector, liquid crystal on silicon, or the like.

Although electronic device 700 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined. For example, electronic device 700 may be communicably connected to an additional electronic device 770 across a network 760. According to some embodiments, the electronic device 770 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. In some embodiments, electronic device 770 may include a processor 775, or multiple processors of one or more types, and a memory 780. In some embodiments, memory 780 may be configured to store instructions executable by processor 775, such as instructions related to the functionality described above with respect to memory 730. Further, electronic device 770 may include I/O device(s) 785 which may be activated or otherwise used in conjunction with gesture input. For example, I/O device(s) may include one or more cameras, displays, or the like, which may be configured to receive input for using gesture input, or provide output generated in response to gesture input.

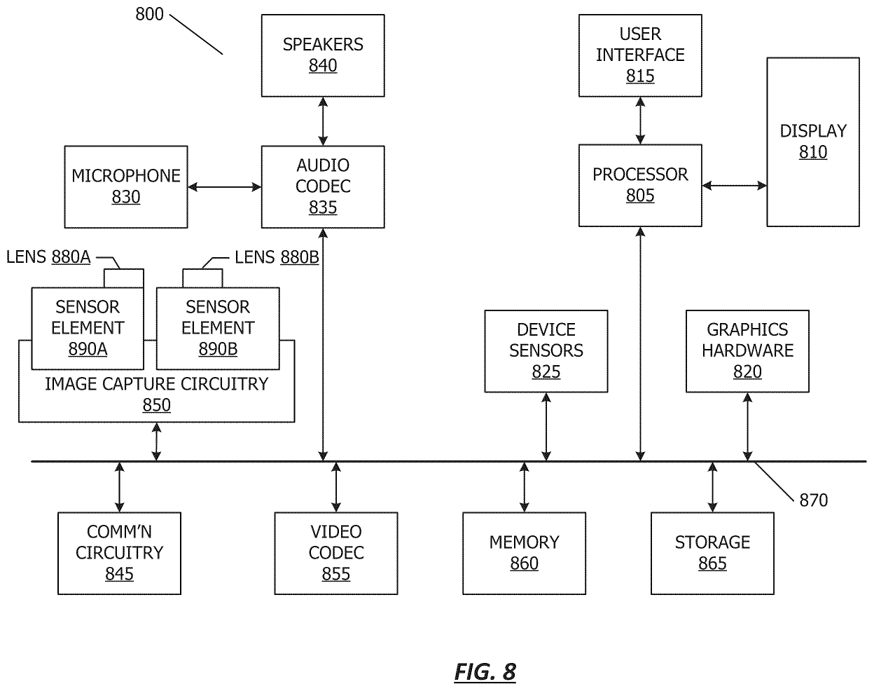

Referring now to FIG. 8, a simplified functional block diagram of illustrative multifunction electronic device 800 is shown according to one embodiment. Each of electronic devices may be a multifunctional electronic device, or may have some or all of the described components of a multifunctional electronic device described herein. Multifunction electronic device 800 may include processor 805, display 810, user interface 815, graphics hardware 820, device sensors 825 (e.g., proximity sensor/ambient light sensor, accelerometer and/or gyroscope), microphone 830, audio codec(s) 835, speaker(s) 840, communications circuitry 845, digital image capture circuitry 850 (e.g., including camera system), video codec(s) 855 (e.g., in support of digital image capture unit), memory 860, storage device 865, and communications bus 870. Multifunction electronic device 800 may be, for example, a digital camera or a personal electronic device such as a personal digital assistant (PDA), personal music player, mobile telephone, or a tablet computer.

Processor 805 may execute instructions necessary to carry out or control the operation of many functions performed by device 800 (e.g., such as the generation and/or processing of images as disclosed herein). Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen, touch screen, gaze, and/or gestures. Processor 805 may also, for example, be a system-on-chip such as those found in mobile devices and include a dedicated GPU. Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include two (or more) lens assemblies 880A and 880B, where each lens assembly may have a separate focal length. For example, lens assembly 880A may have a short focal length relative to the focal length of lens assembly 880B. Each lens assembly may have a separate associated sensor element 890A and 890B. Alternatively, two or more lens assemblies may share a common sensor element. Image capture circuitry 850 may capture still and/or video images. Output from image capture circuitry 850 may be processed by video codec(s) 855 and/or processor 805 and/or graphics hardware 820, and/or a dedicated image processing unit or pipeline incorporated within circuitry 865. Images so captured may be stored in memory 860 and/or storage 865.

Sensor and camera circuitry 850 may capture still and/or video images that may be processed in accordance with this disclosure, at least in part, by video codec(s) 855 and/or processor 805 and/or graphics hardware 820, and/or a dedicated image processing unit incorporated within circuitry 850. Images so captured may be stored in memory 860 and/or storage 865. Memory 860 may include one or more different types of media used by processor 805 and graphics hardware 820 to perform device functions. For example, memory 860 may include memory cache, read-only memory (ROM), and/or random-access memory (RAM). Storage 865 may store media (e.g., audio, image, and video files), computer program instructions or software, preference information, device profile information, and any other suitable data. Storage 865 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 860 and storage 865 may be used to tangibly retain computer program instructions, or code organized into one or more modules and written in any desired computer programming language. When executed by, for example, processor 805 such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-6 or the arrangement of elements shown in FIGS. 1 and 7-8 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining hand tracking data for a first hand based on sensor data;
detecting a first input gesture by the first hand based on the hand tracking data;
determining a current state of the first hand from a group consisting of an active state and an inactive state, wherein the active state is associated with a first set of parameters for the first input gesture, and wherein the inactive state is associated with a second set of parameters for the first input gesture; and
determining whether to initiate an input action associated with the first input gesture based on the first set of parameters or second set of parameters in accordance with the current state of the first hand.

2. The method of claim 1, wherein a probability that the hand tracking data causes the input action to be initiated in the active state is greater than a probability that the hand tracking data causes the input action to be initiate in the inactive state.

3. The method of claim 1, further comprising, while the first hand is in the active state:
determining that an inactive criterion is satisfied; and
in accordance with a determination that the inactive criterion is satisfied, determining that the first hand is in an inactive state.

4. The method of claim 3, wherein the inactive criterion comprises a timeout.

5. The method of claim 3, further comprising:
transitioning the first hand from the inactive state to the active state in response to initiating the input action associated with the first input gesture based on the second set of parameters.

6. The method of claim 1, further comprising, while the first hand is in the inactive state:
determining that an active criterion is satisfied; and
in accordance with a determination that the active criterion is satisfied, determining that the first hand is in the active state.

7. The method of claim 1, further comprising:
obtaining hand tracking data for a second hand based on the sensor data;
detecting a second input gesture by the second hand based on the hand tracking data;
determining whether the second hand is in an active state; and
in accordance with a determination that the first hand is not in the active state, disregarding the second input gesture while performing the input action.

8. A non-transitory computer readable medium comprising computer readable code executable by one or more processors to:
obtain hand tracking data for a first hand based on sensor data;
detect a first input gesture by the first hand based on the hand tracking data;
determine whether the first hand is in an active state or an inactive state;
in accordance with a determination that the first hand is in the active state, initiate an input action associated with the first input gesture based on a first set of parameters; and
in accordance with a determination that the first hand is in the inactive state, initiate an input action associated with the first input gesture based on a second set of parameters different from the first set of parameters.

9. The non-transitory computer readable medium of claim 8, wherein a probability that the hand tracking data causes the input action to be initiated in the active state is greater than a probability that the hand tracking data causes the input action to be initiate in the inactive state.

10. The non-transitory computer readable medium of claim 8, further comprising computer readable code to, while the first hand is in the active state:
determining that an inactive criterion is satisfied; and
in accordance with a determination that the inactive criterion is satisfied, determining that the first hand is in an inactive state.

11. The non-transitory computer readable medium of claim 10, further comprising computer readable code to:
transition the first hand from the inactive state to the active state in response to initiating an input action based on the second set of parameters.

12. The non-transitory computer readable medium of claim 8, further comprising computer readable code to, while the first hand is in the inactive state:
determine that an active criterion is satisfied; and
in accordance with a determination that the active criterion is satisfied, determine that the first hand is in the active state.

13. The non-transitory computer readable medium of claim 8, further comprising computer readable code to:
obtain hand tracking data for a second hand based on the sensor data;
detect a second input gesture by the second hand based on the hand tracking data;
determine whether the second hand is in an active state; and
in accordance with a determination that the first hand is not in the active state, disregard the second input gesture while performing the input action in accordance with the first input gesture.

14. The non-transitory computer readable medium of claim 8, wherein the first input gesture is performed by the first hand and a second hand, and wherein initiating the input action comprises transitioning the second hand to the active state.

15. A system comprising:
one or more processors; and
one or more computer readable media comprising computer readable code executable by the one or more processors to:
obtain hand tracking data for a first hand based on sensor data;
detect a first input gesture by the first hand based on the hand tracking data;
determine whether the first hand is in an active state or an inactive state;
in accordance with a determination that the first hand is in the active state, initiate an input action associated with the first input gesture based on a first set of parameters; and
in accordance with a determination that the first hand is in the inactive state, initiate the input action associated with the first input gesture based on a second set of parameters different from the first set of parameters.

16. The system of claim 15, further comprising computer readable code to, wherein a probability that the hand tracking data causes the input action to be initiated in the active state is greater than a probability that the hand tracking data causes the input action to be initiate in the inactive state.

17. The system of claim 16, wherein the inactive criterion comprises a timeout.

18. The system of claim 16, further comprising computer readable code to:
transition the first hand from the inactive state to the active state in response to initiating an input action based on the second set of parameters.

19. The system of claim 15, further comprising computer readable code to:
obtain hand tracking data for a second hand based on the sensor data;
detect a second input gesture by the second hand based on the hand tracking data;
determine whether the second hand is in an active state; and
in accordance with a determination that the first hand is not in the active state, disregard the second input gesture while performing the input action.

20. The system of claim 15, wherein the first input gesture is performed by the first hand and a second hand, and wherein initiating the input action comprises transitioning the second hand to the active state.
